(19) United States
(12) Patent Application Publication
(10) Pub. No.: US 2022/0305431 A1
(43) Pub. Date: Sep. 29, 2022

(54) METHOD AND APPARATUS FOR REMOVING GREENHOUSE GASES AND AIR POLLUTANTS FROM THE ATMOSPHERE

(71) Applicant: Harshul Thakkar, Douglasville, GA (US)

(72) Inventor: Harshul Thakkar, Douglasville, GA (US)

(21) Appl. No.: 17/616,817

(22) PCT Filed: May 22, 2020
(86) PCT No.: PCT/US20/34200

§ 371 Date: Dec. 6, 2021

Related U.S. Application Data
(60) Provisional application No. 62/880,642, filed on Jul. 30, 2019.
(60) Provisional application No. 62/858,605, filed on Jun. 7, 2019.

(51) Int. Cl. B01D 53/06; G06Q 50/26; B64C 39/02

(52) U.S. Cl. CPC B01D 53/06; G06Q 50/26; B64C 39/024; B64C 2201/12; B01D 2258/06

(57) ABSTRACT

A process, an article of manufacture, and a product for efficient and cost-effective capture of greenhouse gases and air pollutants directly from the air using an unmanned vehicle including materials reclaimed from the atmosphere. The materials can be fabricated into either the actual body structure of a mobile device, into a covering or coating of the body of the mobile device or into a shape suitable for transport by the mobile device by employing any advanced technique such as (but not limited to) 3D-printing technique, laser technique and extrusion technique. The mobile device, with the incorporated materials, is deployed into the atmosphere to capture greenhouse gases and reduce atmospheric pollution in an effort to mitigate the devastating effects of global warming and unhealthy air quality.

### CROSS-REFERENCE TO RELATED APPLICATION

This application is a National Stage Application of PCT Application No. PCT/US2020/034200, filed on May 22, 2020, by Harshul Thakkar, which claims the benefit of and priority to U.S. Provisional Patent Application No. 62/858,605, filed on Jun. 7, 2019, by Harshul Thakkar, entitled 3D-Printed Sorbent-Based Unmanned Aerial Vehicle To Capture Greenhouse Gases From Air To Mitigate Climate Change and 62/880,642 filed on Jul. 30, 2019, by Harshul Thakkar, entitled Development Of A Mobile Capture System for Direct Air Capture the entire contents of which are hereby incorporated by reference as if set forth in their entirety.

### FIELD OF THE INVENTION

The present disclosure refers to an unmanned aerial vehicle operable to remove greenhouse gases or air pollutants from the atmosphere, and further sequestering and making said greenhouse gases and air pollutants into useful materials.

### BACKGROUND

Climate change has been and continues to be an important global concern. It is understood that climate change is a result of increased concentration of greenhouse gases (GHG) in the atmosphere, which in turn increases the average global temperature. Greenhouse gases increase the global temperature by absorbing heat from the sun, in effect, trapping the heat in the atmosphere by not allowing its dissemination from the atmosphere and later radiating the absorbed heat. When these greenhouse gases emit heat, this heat in effect increases global temperatures which results in the increased temperature of the earth's climate system.

This increase of temperature of the Earth's climate system includes increases of the temperature of large bodies of water, such as oceans. Oceanic temperature is critical in controlling the climate and changes in temperature have been linked to extreme weather systems such as hotter heat waves, more frequent droughts, heavier rainfall, and more powerful hurricanes. Changes in the climate have also been found to have a lasting and destructive effect on many ecosystems. Increased global temperatures are disrupting habitats such as coral reefs and alpine meadows, which can drive many plant and animal species to extinction. Climate change has also been linked to an increase in allergies and respiratory illnesses in humans. Further, increased temperatures cause higher than normal growth of pollen-producing ragweed, making the outbreaks of infectious diseases more common. Conditions caused by global warming are favorable to the growth of pathogens and the spread of pathogen carrying mosquitoes. As described, global warming has a ubiquitous effect on global livelihood, and it is critical to address these issues and reduce its effects by reducing the concentration of greenhouse gases in the atmosphere.

The main gases associated with climate change are methane (CH₄), nitrous oxides (N2O), fluorinated gases, halogenated gases and most importantly carbon dioxide (CO₂). Carbon dioxide concentrations have increased substantially since the beginning of the industrial era, rising from an annual average of 280 ppm (parts per million) in the late 1700's to 413 ppm as measured in 2019, which is a 68% increase. The unprecedented increase in carbon dioxide concentrations in the atmosphere is mainly attributed to human industrial activities. The concentration of methane in the atmosphere has more than doubled since preindustrial times, reaching approximately 1,800 ppb (parts per billion) in recent years. The concentration of methane in 1950 was recorded to be about 1100 ppb and in 2015 that number has risen to 1800 ppb, which is a 40% increase in atmospheric methane concentrations.

Halogenated gases also known as ozone depleting gases were essentially zero a few decades ago but have increased rapidly as they have been incorporated into industrial products and processes. Ozone depleting substances make our planet more susceptible to ultraviolet (UV) radiation. The atmospheric ozone layer is a protective layer, that absorbs UV radiation and its depletion allows more UV radiation to reach the earth's surface causing increased instances of skin cancer and cataracts in humans.

Each of these gases has a varying global warming potential, which is the measure of the radiative effect of each unit of gas over a specified period of time, expressed relative to radiative effect of carbon dioxide. An amount of gas with high global warming potential will warm the Earth more than the same amount of carbon dioxide. For example, methane has a global warming potential of approximately 30 times that of carbon dioxide. Furthermore, each of the gases has a varying atmospheric lifetime, which measures how long a gas stays in the atmosphere before natural processes remove them. A gas with a long lifetime can exert more warming influence than a gas with a short lifetime. Thus, it is prudent and important to remove gases with a higher global warming potential and a high atmospheric lifetime from the atmosphere more efficiently and cheaply in order to reduce the present concentration of these gases from the atmosphere.

The majority of greenhouse gases are emitted into the atmosphere as a byproduct of industrial processes by large fixed-point sources directly resulting from burning of fossil fuels, including coal. The rest of the greenhouse gases are generated as a result of agriculture, waste, and other industries. Large fixed-point sources are where pollutants and contaminants come from a single location such as a chimney, flue, or a channel of an industrial factory. Non-point source pollution results when contaminants are introduced into the environment over a large, widespread area, such as people driving cars, commercial heating, or where harmful pollutants enter the soil either from the air or water.

Generally, there are two locations of capturing greenhouse gases, first, is separating greenhouse gases at a fixed large-point sources, such as exhausts and flues. The second mechanism is known as direct air capture (DAC) where greenhouse gases are captured and removed from ambient air. Common methods such as absorption (carbon scrubbing using amines), adsorption, or membrane gas separation technologies are currently being used in either direct air capture or fixed large point source capture.

A typical chemical absorption process is used to strip or scrub CO2. The process consists of an absorber such as alkonalamines and a stripper in which absorbent is thermally regenerated at high temperatures. The process is energy intensive, even though they are commonly used in practice.

Unlike absorption, adsorption process can be achieved using either physical, chemical or electrical adsorption techniques. Adsorption is the phenomenon where gas is adsorbed into a solid or liquid under desired pressure and temperature and desorbed using various approaches such as (but not limited to) reduced pressure, increased temperature, applying electric current, steam, and vacuum. Adsorption is the process where molecules, atoms, or ions adhere to the surface of an adsorbent and are then expelled.

In addition to adsorbents, gas separation can be carried out using membranes that allow penetration by desired gas while reflecting the other gases. The process of separation using membranes could also be carried out by designing membranes that allow penetration by other gases while reflecting the desired gas or vice versa. These greenhouse gases are later expelled, and the membrane may be reused.

Catalysis is the process carried out by using catalysts to convert CO2 into other chemical compounds.

All of the abovementioned processes use materials in various engineered shapes such as beads, pellets, foams, fibers, sheets, and monoliths.

Technologies that use the concept of removing CO2 directly from the air are configured to drive direct polluted air into a capture device where greenhouse gases such as carbon dioxide are captured usually by either absorption, adsorption, or membrane gas separation. These captured greenhouse gases are later removed and either disposed and sequestered or are utilized for other processes, such as production of plastics. These technologies are not economical and impractical in terms of the complexity and cost of the installation process. The installation is even more impractical in highly populated areas, due to the size, cost, and complexity.

Other technology to capture CO2 from air use membrane materials installed on a conveyer belt that can rise into the atmosphere. Upon capturing CO2, the materials on conveyer belt are pulled down and dipped in the solution to regenerate materials. Once the materials are regenerated, materials are again exposed to atmospheric air to capture CO2. The process is repeated to capture CO2 continuously from the air. However, this technology heavily relies on wind speed i.e. CO2 pressure in wind. If the pressure is lower, the CO2 capture efficiency decreases, and it may take a very long time to capture CO2.

These direct air capture technologies entail drawbacks such as consumption of huge land areas, and technical uncertainty. According to the assessed direct air capture model, direct air carbon capture and storage industries to use around a quarter of global energy by the end of the century.

According to a report from the National Academics of Science, Engineering and Medicine, the land area required is 7 km² for to remove 1 million metric tons of CO2 per year. Scaled up, this leads to 7000 km² for 1 gigaton CO2 per year. Every year 3.6 gigatons of CO2 is emitted and the land area of 25200 km² would be required to capture all the emitted CO2. That is equivalent to the entire state of Maryland.

Governments and enterprises have tried to address the rising concentration of greenhouse gases in the atmosphere by implementing governmental restrictions on emissions, developing zero emission cars, creating international treaties to set limits on the emission of greenhouse gases, outlawing the use of certain chemicals in industrial processes, and other steps. However, most of these attempts have been futile as evident from the ever-increasing concentrations of greenhouse gases in the atmosphere. For example, the development of the electric car had promising implications, however, poor battery life, lack of availability of charging stations, and the high cost of electric cars has hindered the total transformation from fossil-based vehicles to electric vehicles. Another example of clean vehicle is hydrogen-based vehicles. Hydrogen is used as a fuel and the exhaust for hydrogen-based fuel is water. Although the efforts of bringing new hydrogen fuel-based technology in automobiles is substantial, the complete transformation of different fuel-based car will take decades.

On the other hand, air pollutants such as (but not limited to) carbon monoxide (CO), nitrogen oxide (NO), nitrogen dioxide (NO2), and particulate matter (PM) have tremendously deteriorated the air quality. These pollutants can cause lethal diseases such as (but not limited to) cancer and asthma. Such pollutants are emitted into the atmosphere by abovementioned stationary-point resources as well as nonstationary-point resources.

Both air pollutants and greenhouse gases have proven to show negative impacts on living beings, air quality and climate.

Despite promising technologies and efforts made to address the air pollutants and greenhouse gases, such efforts have been futile in circumventing atmospheric-dirt and its devastating effects. However, there is still an urgent need for an effective, efficient and cost-efficient atmospheric-dirt removal method which also uses a lot less land area.

The problems identified above are not intended to be exhaustive but rather are among many which tend to illustrate the need for an improved greenhouse gas and other pollutant gas capturing mechanism that is more economical and efficient.

### SUMMARY OF THE INVENTION

The present disclosure relates to the development of a mobile device and its manufacturing method, to act as a removal device of greenhouse gases and air pollutants (may be referred to as “atmospheric-dirt”) directly from the air. The disclosure involves the fabrication of materials into a mobile device shape that may remove atmospheric-dirt.

One embodiment may be a method of removing pollutants from the atmosphere, the steps comprising: providing an unmanned aerial vehicle/system; equipping the unmanned aerial vehicle with a pollutant collector; and operating the unmanned aerial vehicle in areas having pollutants. The pollutant collector may be sorbent. The pollutant collector may be manufactured from a paste comprising materials.

Another embodiment may be an apparatus for removing pollutants from the atmosphere, comprising; a mobile device; and a pollutant collector. The pollutant collector may be sorbent. The pollutant collector may be attachable to the mobile device and replaceable therefrom. The pollutant collector may be manufactured. A structural portion of the mobile device may be manufactured from a material including pollutants. The mobile device may be an unmanned aerial vehicle. The mobile device further may comprise a system selected from the group consisting of electric cell, pressure swing adsorption, membrane separation, and catalytic systems.

Another embodiment may be an apparatus for removing pollutants from the atmosphere, comprising; a mobile device; wherein the mobile device may comprise a pollutant collector. The pollutant collector covers a substantial portion of a body of the mobile device. A body of the mobile device may comprise the pollutant collector. The body of the mobile device may be manufactured from a technique selected from the group consisting of mold-casting, cutting, laser-cutting, or extrusion. The mobile device may be an unmanned aerial vehicle. The mobile device further may comprise a system selected from the group consisting of: electric cell, sorption, membrane separation, and catalytic systems.

Another embodiment may be a sorbent material, comprising a paste; wherein the paste may comprise a removal-material powder, a binder, a co-binder, a plasticizer, and a solvent. The paste may be processed via additive manufacturing (referred to herein as “AM”) or other manufacturing techniques into a pollutant collector. The paste further may comprise a material that may be selected from the group consisting of: organic, inorganic, partially organic, polymers, clay, inorganic oxides, and their combination. The paste may be homogenous.

Fabrication of materials into a desired mobile device shape may be accomplished by using various manufacturing techniques, comprising mold-casting, conventional extrusion, and AM. In some embodiments, the mobile device may be an unmanned aerial vehicle.

AM technologies may be further categorized into sub-technologies comprising 3D-printing, inkjet printing, selective laser sintering (referred to herein as “SLS”), extrusion free forming (referred to herein as “EFF”), fused deposition modeling (referred to herein as “FDM”), stereo-lithography (referred to herein as “SL”), and laminated object manufacturing (referred to herein as “LOM”).

Though any fabrication technology may be used in the present disclosure, 3D-printing technology is primarily used herein for the purposes of illustration and description. 3D-printing technology may create designs utilizing different materials such as sorbents, catalysts, or membranes that remove atmospheric-dirt.

The materials used in AM processes may comprise adsorbents, catalysts, and membranes for cleaning atmospheric dirt and pollution, and in some embodiments may be referred to as “removal materials”.

Powder based removal materials may be fabricated by AM into desired shapes, such as pellets, beads, foam, spiral, fibers, monoliths, and plates by using various available techniques, which may have potential for large-scale processes.

In one embodiment, removal materials may be fabricated into portions of a mobile device or attachments thereto, wherein these materials include the functionality of cleaning atmospheric dirt. Some mobile device shapes may comprise unmanned aerial vehicles (UAVs), solar gliders, unmanned aerial systems (UAS), vertical take-off and landing systems (VTOL), or any other controlled device. This ability to process these removal materials using conventional and AM into shapes of mobile devices may be a cost-effective and efficient mechanism for removing atmospheric-dirt directly from the air. Preferably, the mobile devices have a high degree of movement to cover a large amount of space.

In different embodiments, there may be: (1) a self-standing mobile device where the actual body of the mobile device is made of the removal material(s); (2) a mobile device coated or covered with removal material(s); and (3) a mobile device with the ability to carry a cartridge or container comprising removal material(s). These removal materials encompassing mobile device may be extended to any varying configuration, shape, size, and dimension.

Unmanned aerial vehicles, often referred to as drones, are primarily used herein for the purposes of illustration and description.

In one embodiment, the physical structure of the drone may be made from the removal material(s). Using AM and conventional methods, the structure of the drone may be fabricated using the removal material(s) and assembled into a functioning aerial drone.

In another embodiment, a drone may be encased with removal material(s) fabricated using AM or conventional manufacturing methods. This may be done by fabricating removal-material(s) into desired drone shapes configured to fit on or cover most of the external body of the drone. Alternatively, the drone may be coated using different coating methods such as (but not limited to) wash coated, spray coated, in-situ coated, layer-by-layer coated, hydrothermal coated, or physical/chemical vapor deposited with the removal material(s).

In another embodiment the drone may comprise a carrier or cartridge made of the desired removal materials. A sorbent-based carrier may be of any design and shape such that it allows secure attachment to the drone. For example, in the case of solid sorbents, the cartridge may be configured to function as packed-bed reactors filled with sorbent powder, pellets, beads, ionic liquids, monoliths or any other configuration. In addition, the carrier or cartridge may be attached to drones to perform atmospheric-dirt removal processes such as adsorption, membrane separation, catalysis, and absorption.

The selection of materials may depend on two major factors: 1) affinity towards a desired atmospheric-dirt molecule; and 2) structural, physical and mechanical properties of materials capable of high capture-ability in operating conditions. Materials such as amine incorporated zeolites, metal-organic frameworks (MOFs), zeolite imidazolate frameworks (ZIFs), carbon, and silicas, have demonstrated considerable CO₂ uptake in humid environments at lower CO₂ concentrations. Some zeolite structures such as Linde Type A (LTA) and faujasite (FAU) have shown significant CO₂ uptakes in dry conditions. Another example includes removal of NOx from the air by using zeolite structure chabazite (CHA) loaded with or without metal(s). The make-up of the materials may vary according to the type of target atmospheric-dirt molecule, the atmospheric conditions, and other environmental factors.

In general, porous, non-porous, liquids or their combination may be used to remove atmospheric dirt. These materials include, but not limited to, zeolites, covalent organic frameworks (COFs), MOFs, ZIFs, carbons, polymers, alkali oxides, carbonates, organic-inorganic hybrid sorbents, composites, alkylamines/amines, ionic liquid-based materials, hydrotalcites, silicas, alkylamines, amines, amine incorporated sorbents, ionic liquids, ionic liquid-based materials bare metal-oxides, alkali oxides, hydrotalcites, hybrid materials, silicas and metal-doped materials.

Once the selection of the materials is finalized, the materials may be mixed with suitable additives such as binding agent(s), plasticizer(s), co-binder(s) and solvent(s). Binding agents may be used to bind sorbent particles and enhance its mechanical properties. Plasticizer(s) may be used to adhere binder and sorbent particles. Co-binder(s) may be used to stabilize the entire structure. Solvent(s) may be to mix additive(s) and sorbent(s) to form an extrudable paste/ink. The additives may be organic or inorganic depending on the nature of the sorbent.

In order to achieve a smooth final product, the weight fraction of the additives may be optimized. A smooth final product is important as it will allow for a high-quality AM or conventionally manufactured product. The final shape of the mobile device may also be achieved without using additives or solvents.

The desired removal materials and additives may be prepared into a homogeneous paste and be transferred to an AM or conventional manufacturing fabrication tool in order to print the desired drone shape. Once the desired drone shape is prepared, the drone may be flown in air to capture atmospheric dirt, air pollutants, and greenhouse gases.

The approach of fabrication may vary depending upon the technique used. For example, if laser-printing is employed, the laser may cut the materials into a desired shape.

After the removal material-based drone has removed atmospheric-dirt to its maximum capacity, the materials may be regenerated. The regeneration process may carry out using techniques such as, but not limited to, thermal energy (100-120° C.), microwave frequency, solar heating or other compatible means of cleansing the materials of the captured atmospheric-dirt, pollutants, and greenhouse gases.

Once the captured gases or vapors have been isolated and extracted from the materials, it can be flown again for another cycle of removing of atmospheric-dirt. The process of removal and regeneration may be repeated for multiple cycles.

Other features and advantages will become apparent to those skilled in the art from the following detailed description and its accompanying drawings.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of an in-progress layer-by-layer deposition of desired materials into a drone shape by employing 3D-printing technique.

FIG. 2A is an illustration of several layers of one embodiment of the desired materials deposited to form an initial base layer of the drone.

FIG. 2B is an illustration of several layers of one embodiment of the desired materials deposited to complete the base portion of the drone.

FIG. 3A is an illustration of one embodiment of the two identical components that may make up the body of one embodiment of a drone.

FIG. 3B is an illustration of one embodiment of an assembly of the base portion and the top portion of the drone such that they create the drone body.

FIGS. 4A-B are illustrations of one embodiment of a drone manufactured out of removal-materials body.

FIGS. 5A-B are illustrations of an embodiment of a drone cover for use with a drone.

FIG. 6 is an illustration showing a drone having a coating applied.

FIG. 7 is an illustration showing an embodiment of a drone having a sorbent-based cartridge or carrier.

FIG. 8 is a flow diagram showing a method of removing atmospheric-dirt using an AM or 3D-printed material-based UAV drone.

### DETAILED DESCRIPTION OF THE DRAWINGS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

As used herein, “pollutant” may include, but not be limited to, carbon monoxide (CO), nitrogen oxide (NO), nitrogen dioxide (NO2), particulate matter (PM), greenhouse gases, other substances that may have a negative effect on climate, and other substances in the air that have a negative effect on air quality.

As used herein a “sorbent” may include materials such as, but not be limited to, zeolites, covalent organic frameworks (COFs), MOFs, ZIFs, carbons, polymers, alkali oxides, carbonates, organic-inorganic hybrid sorbents, composites, alkylamines/amines, ionic liquid-based materials, hydrotalcites, silicas, alkylamines, amines, amine incorporated sorbents, ionic liquids, ionic liquid-based materials bare metal-oxides, alkali oxides, hydrotalcites, hybrid materials, silicas and metal-doped materials. These materials may act as sorbents, membranes, catalysts or combination thereof.

An embodiment of the AM or conventionally fabricated sorbent-based unmanned aerial vehicle is described herein. However, it will be clear and apparent to one skilled in the art that the invention is not limited to the embodiments set forth herein. The AM or conventionally manufactured removal-material based unmanned aerial vehicle is meant to mitigate climate change and pollution by removing greenhouse gases and pollutants, respectively, from the atmosphere. This invention is a cost effective and efficient way to capture greenhouse gases from the atmosphere.

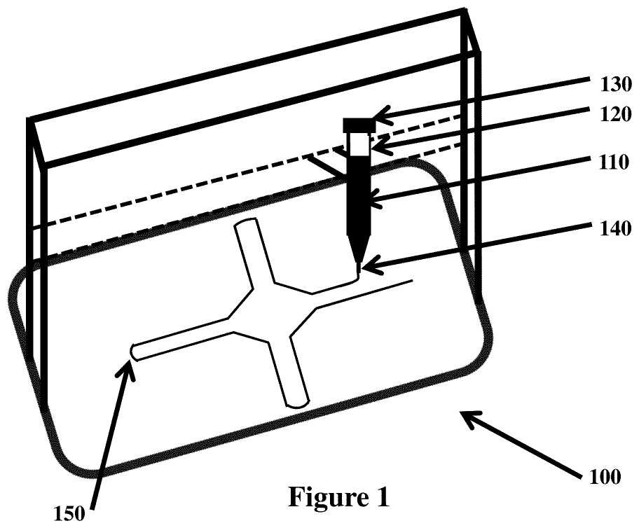

FIG. 1 is an illustration of an in-progress layer-by-layer deposition of desired materials into a drone shape by employing a 3D-printing technique 100.

As shown in FIG. 1, a paste 110 may be used in a 3D-printer's 100 extruder-tube 120. A receiver head 130 of the 3D printer 100 may be connected to the extruder-tube 120 whereas the other side of the receiver head 130 may be connected to an air compressor, digital syringe dispenser, or use a motor extruder to extrude the paste 110 in layer-by-layer manner. The extruder-tube 120 may be fastened to a 3D-printer extruding holder 130. A nozzle 140 of desired diameter may be connected to the extruder-tube 120 on the extruding side. Operating conditions such as printing speed, air flow pressure, height of the nozzle from the printing plate, may vary depending on the viscosity of the paste 110. Modeling software may be used to create a drone shape design which may then be exported to the 3D printer's 100 software, and thereby cause a layer-by-layer extrusion 150 of the paste 110. In a preferred embodiment, the paste 110 may comprise a removal material. In some embodiments, removal materials may comprise adsorbents, catalysts, and membranes useful for cleaning atmospheric dirt, pollution, and greenhouse gases.

The paste 110 may be prepared by combining pulverized removal-material with additives and homogenized. The additives may comprise binder(s), co-binder(s), plasticizer(s), and solvent(s). The additives may comprise at least one binder or solvent that is selected from the group consisting of organic, inorganic, partially organic, clay, and inorganic oxides, in a range from 0-98 wt %. Additives with varied and optimized weight fractions may be mixed with pulverulent removal-material to create a homogeneous, viscous, and extrudable paste. Structures made from the paste 110 with removal-materials may be considered pollutant collectors.

3D printing may be used to create the physical structure of the drone, a 3D covering in the shape of the drone structure, a cartridge comprising removal-material that may be carried by the drone, or any combination thereof. The cartridge may be configured to be easily removed and replaced.

In one embodiment, any conventional or other AM fabrication techniques may be used instead of 3D printing.

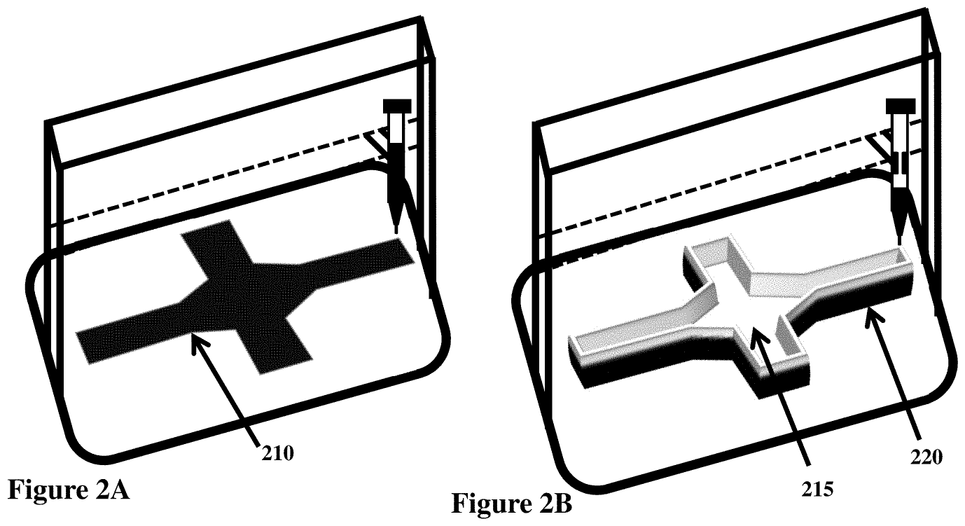

FIG. 2A is an illustration of several layers of desired materials deposited to form an initial base layer of the drone and a completed base portion of the drone, respectively. In this embodiment,

As shown in FIG. 2A, an initial base layer of the drone 210 may be deposited in the shape of the drone.

As shown in FIG. 2B, the completed base portion of the drone 220 may be built upon the shape of the initial base layer of the drone 210. The completed base portion of the drone 220 may have an internal cavity 215 for receiving and installing other drone components, including drone parts and electronics.

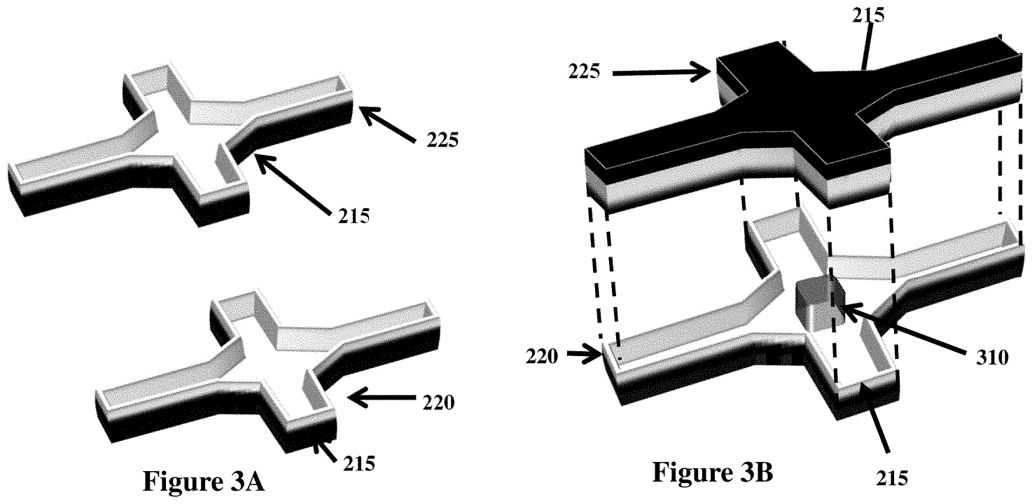

FIG. 3A is an illustration of two identical components that make up the body of one embodiment of a drone.

FIG. 3B is an illustration of an assembly of the base portion and the top portion of the drone such that they create the drone body.

As shown in FIG. 3A, two body parts, a top portion 225 and bottom portion 220 may constitute the drone body. They may be identical or substantially identical in shape and size and may be attached in a face-to-face orientation such that the internal cavity 215 of the top portion 225 and bottom portion 220 to create the drone body.

As shown in FIG. 3B, an electronic configuration module 310 may be housed within the internal cavity 215. The electronic configuration module 310 may act as an internal computer and control module.

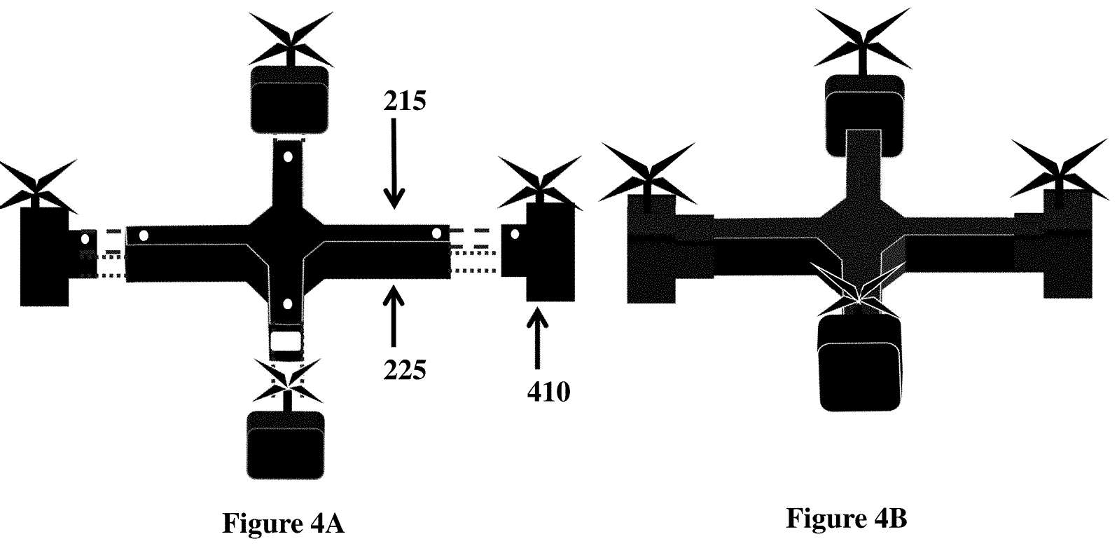

FIGS. 4A-B are illustrations of one embodiment of a drone body with drivers. As shown in FIGS. 4A-B, a drone body comprising a top and bottom portion 215, 225 may have one or more drivers 410 affixed. The drivers 410 may be propeller assemblies, jet assemblies, compressed air assemblies, or other mechanisms for moving the drone body comprising a top and bottom portion 215, 225. In this embodiment, the drone body comprising a top and bottom portion 215, 225 preferably comprises a removal material and are fabricated using conventional manufacturing or AM.

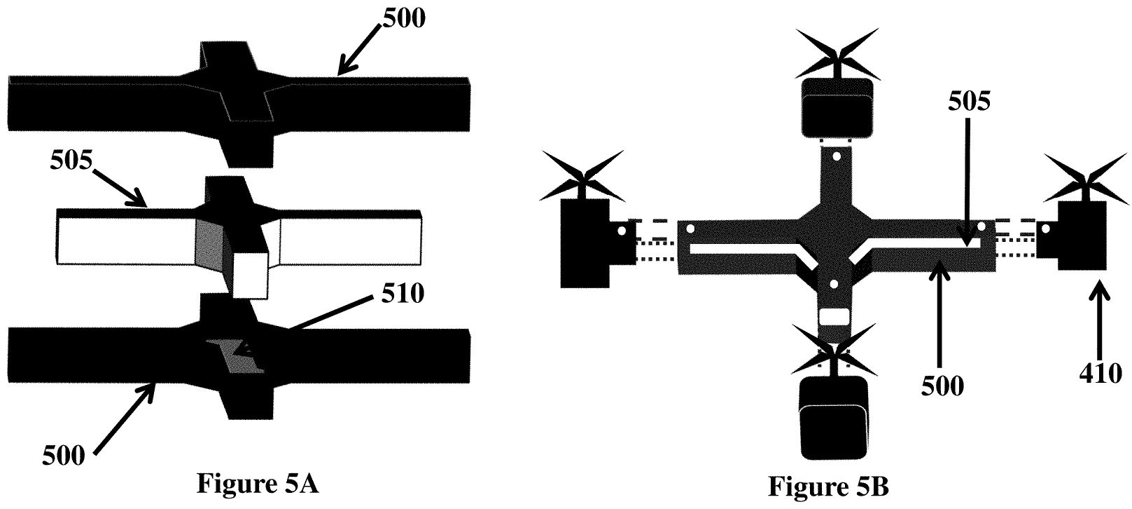

FIGS. 5A-B are illustrations of an embodiment of a drone cover for use with a drone. As shown in FIGS. 5A-B, a drone body 505 may be encapsulated by one or more drone body covers 500. The drone body covers 500 may comprise an internal cavity 510 configured to receive and secure the drone body 505. The drone body covers 500 preferably comprise a removal material and are AM or 3D printed. Preferably the removal material comprises a sorbent-based covering.

As shown in FIG. 5B, one or more drivers 410 may engage the drone body covers 500. In one embodiment, the drivers 410 may engage the drone body covers 500 and/or the drone body 505 in order to keep the drone body covers 500 engaged with the drone body 505.

In one embodiment, drivers may be attached prior, during or after the fabrication process.

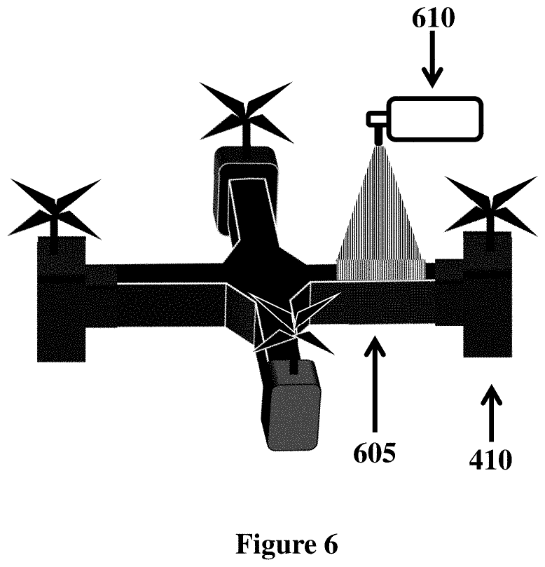

FIG. 6 is an illustration showing a drone having a coating applied. As shown in FIG. 6, a drone body 605 may have a coating applied to it by a spraying device 610. Preferably, the coating comprises a removal material that is sorbent based.

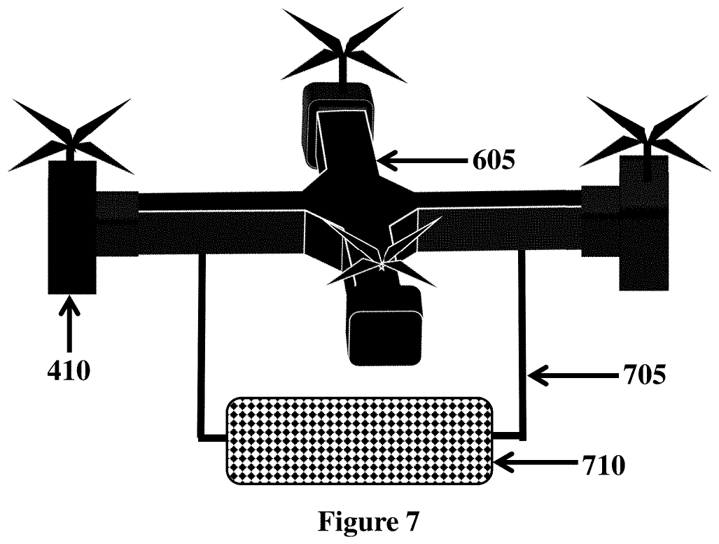

FIG. 7 is an illustration showing an embodiment of a drone having a sorbent-based cartridge or carrier. As shown in FIG. 7, the drone body 505 may comprise a carrying mechanism 705 which may function to connect a cartridge 710. In one embodiment, the carrying mechanism 705 may comprise a rigid attachment structure. The cartridge 710 may be a sorbent material that is configured to easily release from said carrying mechanism 705 and be replaced.

In one embodiment, cartridge or carrier may be of any size, and shape. Cartridge or carrier may be installed strategically to maximize the removal of greenhouse gases and air pollutants.

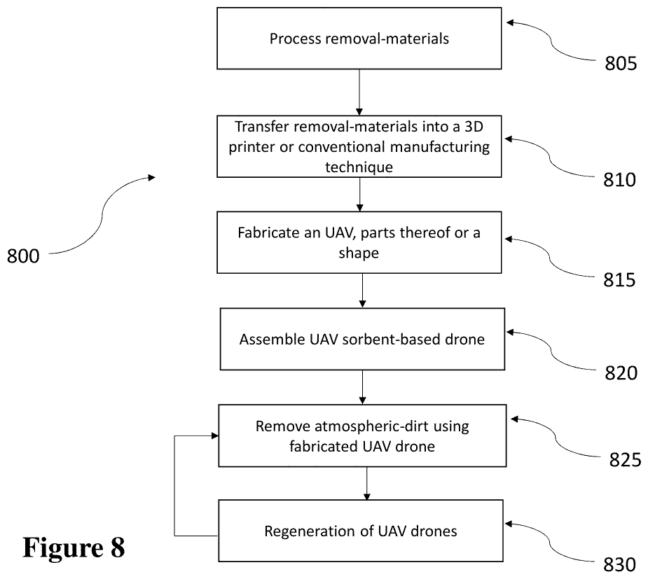

FIG. 8 is a flow diagram showing a method of removing atmospheric-dirt using a 3D-printed material-based UAV drone 800.

First, the removal-material is processed 805. The removal materials may be made according to the embodiments discussed above. Then, the removal-material may be transferred into a 3D printing machine or conventional manufacturing system 810. The 3D printing machine may print a whole UAV body containing the removal materials or prints UAV enclosures made of the materials or prints a removal materials-based shape that may be carried by the UAV 815. The removal materials-based UAV may be assembled depending on one of the embodiments discussed hereinabove 820. In the next step, the removal materials-based UAV may be flown in order to remove atmospheric-dirt 825. Finally, the 3D printed UAV may be regenerated using energy such as but not limited to thermal energy, dipping in a solvent that dissolves/removes atmospheric-dirt, microwave energy, and solar energy 830. After regenerating, 3D-printed removal-material drones may be employed again for removing atmospheric-dirt. The process of capturing and regenerating of 3D printed removal-material drones can be repeated for multiple cycles.

In one embodiment, any conventional or AM fabrication methods may be used to manufacture material-based UAV drones.

As used herein, a mobile device may be any controlled flying object or terrestrial object. Some examples of a mobile device may comprise unmanned aerial vehicles (UAVs), solar gliders, unmanned aerial systems (UAS), vertical take-off and landing (VTOL) systems, or any other controlled device. In some embodiments, the mobile device may be a bi-copter, quadcopter, hexa-copter, octocopter, multi-copter, helicopter, airplanes or any other controlled flying object. In some embodiments, the mobile device may be equipped with technologies such as artificial intelligence, hearing tape, heating cables, pressure regulators, sensors and anti-collision lights.

The mobile device may use any type of batteries, including Li—Po, and graphite. The mobile device may use any type of fuel, including jet fuels, hydrogen, ammonia, and compressed natural gas to fly. The mobile device can use both batteries and fuel to achieve longer flight-time.

Collision sensors may be used.

Sensors aiding the recognition of high concentrations of polluted areas may be added to the unmanned aerial vehicles to allow for a quick and efficient recognition of where most of the pollution is located. This may allow the drones to target areas where the concentration of pollutants is higher, which may enable increased efficiency in capturing the most amount of pollutants in the least amount of time with the least amount of energy expenditure. These sensors may also measure the amount of pollutants collected and recognize the point of saturation of the sorbent-based material. Furthermore, using a combination of satellites and artificial intelligence (AI), drones may further increase the efficiency of collecting the most amount of pollutants in the least amount of time. By employing machine learning algorithms/AI into the onboard electronics or the remote controlling location, the collecting of greenhouse gases can be conducted on an autonomous or semi-autonomous fashion.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A method of removing pollutants from the atmosphere, the steps comprising:
providing an unmanned aerial system;
equipping said unmanned aerial system with a pollutant collector; and
operating said unmanned aerial system in areas having pollutants.

2. The method of claim 1, wherein said pollutant collector is sorbent.

3. The method of claim 2, wherein said pollutant collector is manufactured from a material comprising removal materials.

4. An apparatus for removing pollutants from the atmosphere, comprising;
a mobile device; and
a pollutant collector.

5. The apparatus of claim 4, wherein said pollutant collector is a sorbent material.

6. The apparatus of claim 5, wherein said pollutant collector is attachable to said mobile device and replaceable therefrom.

7. The apparatus of claim 4, wherein said pollutant collector is manufactured using sorbent materials.

8. The apparatus of claim 4, wherein a structural portion of said mobile device is manufactured from a material comprising removal material.

9. The apparatus of claim 8, wherein said mobile device is an unmanned aerial vehicle.

10. The apparatus of claim 9, wherein said mobile device further comprises a system selected from the group of systems consisting of one or more of: electric cell; pressure swing adsorption;
membrane separation; catalytic; and combinations thereof.

11. An apparatus for removing pollutants from the atmosphere, comprising;
a mobile device;
wherein said mobile device comprises a pollutant collector.

12. The apparatus of claim 11, wherein said pollutant collector covers a substantial portion of a body of said mobile device.

13. The apparatus of claim 11, wherein a body of said mobile device comprises said pollutant collector.

14. The apparatus of claim 13, wherein said body of said mobile device is manufactured from a technique selected from the group of techniques consisting of one or more of: AM, mold-casting; cutting; laser-cutting; extrusion; and combinations thereof.

15. The apparatus of claim 11, wherein said mobile device is an unmanned aerial vehicle.

16. The apparatus of claim 15, wherein said mobile device further comprises a system selected from the group of systems consisting of one or more of: electric cell; pressure swing adsorption; membrane separation; catalytic; and combinations thereof.
